(19) United States
(12) Patent Application Publication
(10) Pub. No.: US 2002/0198924 A1
(43) Pub. Date: Dec. 26, 2002

(54) Process scheduling method based on active program characteristics on process execution, programs using this method and data processors

(76) Inventors: Hideya Akashi, Kunitachi (JP); Keitaro Uehara, Kokubunji (JP); Tsuyoshi Tanaka, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/076,547

(22) Filed: Feb. 19, 2002

(30) Foreign Application Priority Data
Jun. 26, 2001 (JP) 2001-192174

(51) Int. Cl. G06F 9/00

(52) U.S. Cl. 709/102

(57) ABSTRACT

In a computer having a plurality of processors or in a computer cluster system, processing performance is improved by measuring operation characteristics of a process, and by performing process scheduling on the basis of actual measurements of the process operation characteristics.

In the computer or in the computer cluster system, a scheduling function is provided on an operating system that operates in each computer. The scheduling function controls the performance measuring means, which is provided in a processor or a system control circuit inside each computer, and obtains processor operation characteristics of each process. Thereafter, the scheduling function estimates operation characteristics, which will be obtained when executing each process on each processor, on the basis of the processor operation characteristics, and then optimizes assignment of each process to a processor.

### BACKGROUND OF THE INVENTION

The present invention relates to a process scheduling method in a computer system having a plurality of processors, in particular, to a process scheduling method, by which operation characteristics of the processors or the system are dynamically obtained during execution of processes and thereby scheduling is performed on the basis of the operation characteristics, and to a computer system using this method.

In recent years, since a network business market is rapidly expanding, and network computing becomes more advanced, performance required for a computer system is rapidly increasing. In order to achieve improvement in performance of a computer system while making use of investment to existing computers, addition of a processor to the existing computers, or addition of a computer to the existing computer system, is effective.

On the other hand, as a result of rapid development of semiconductor devices, performance of a processor itself and performance of a computer itself are also being improved at high speed. Therefore, for the purpose of improving the performance of the computer system described above, it is desirable to add a processor or a computer, which has higher performance in comparison with processors or computers of the existing computer system.

In current operating systems, when executing a program in a parallel computer having a plurality of processors, a process scheduler instructs the processors to perform assignment processing for each process and each thread (or lightweight process), which constitute a program. In addition, in cluster software, when executing a program in a computer system (cluster system) comprising a plurality of computers, a scheduler instructs the computers to perform assignment processing for each process and each thread. As an example of the cluster software, the following can be named: SUN Microsystems, SUN Cluster Architecture: A White Paper, Cluster Computing, 1999, Proceedings, 1st IEEE Computer Society, International Workshop on, page 331-338.

In the cluster system as described above in which a processor and a computer having different performance characteristics exist, if each process can be assigned to a processor that is suitable for execution of the process, higher performance can be delivered. In Japanese Patent Publication No. 11-31134 (prior art 1), the following method is shown: in a computer having a plurality of processors, each of which has different specifications, program attribute information indicating execution characteristics of a program is added to each program; and a scheduler executes each program using a most suitable processor on the basis of processor characteristic information indicating performance characteristics of each processor and on the basis of the program attribute information. To be more specific, the program attribute information in the prior art 1 is a kind of flag information that shows a form of data processing (such as image processing, communication processing, high-speed technical computing processing, voice processing, or multimedia information processing), or a kind of data to be processed, etc.

### SUMMARY OF THE INVENTION

The prior art 1 performs process scheduling in a computer having processors, each of which has different performance characteristics, on the basis of processor characteristic information and program attribute information, which have been added beforehand. Because of it, in order to perform most suitable process scheduling on the basis of dynamic program characteristics in a cluster system having computers, each of which has different performance characteristics, it is necessary to solve the following problems:

(1) In the prior art 1, it is necessary to add program attribute information corresponding to a program beforehand. Therefore, it is not possible to perform process scheduling on the basis of dynamic program characteristics that are not found out until the program is actually executed.

(2) The prior art 1 does not take process scheduling of a cluster system having computers, each of which has different performance characteristics, into consideration.

(3) Processing performance of a computer is determined by processing performance inside a processor and processing performance outside the processor (mainly, memory system performance). In the prior art 1, process scheduling is performed on the basis of the processor characteristic information. Therefore, process scheduling in response to memory access characteristics of the computer is not taken into consideration.

The present invention solves the problems described above, which have not been solved in the prior arts, and provides an advanced process scheduling method used in a computer having processors, each of which has different performance characteristics, and in a cluster system having computers, each of which has different performance characteristics.

The following are typical configurations for solving the above-mentioned problems, which are disclosed in the present invention:

At least in a part of a plurality of processors included in a computer system, a performance measuring means, which obtains processor operation characteristics while executing a program of the processor, is provided; when executing a process by one of the processors, processor operation characteristics for the process is obtained by controlling the performance measuring means; and on the basis of the processor operation characteristics of each process, which is being executed or can be executed in the computer, a processor, to which each process is assigned, is selected on a priority basis.

As the processor operation characteristics, for example, a ratio of memory access wait time to program execution time, and a memory access size during execution of a program can be used. For example, in decreasing order of the memory access wait time ratio of each process that is being executed or can be executed on the computer system, or in decreasing order of the memory access size of each process, each process is assigned to a processor having the largest cache capacity with first priority. In addition, as another example, in decreasing order of the memory access wait time ratio of each process that is being executed or can be executed on the computer, each process is assigned to a processor having the shortest memory access latency with first priority.

Moreover, on the basis of the memory access size of each process that is being executed or can be executed on the computer, each process is assigned with priority so that a total memory access size of one or more processes, which are assigned to each node, does not exceed memory access performance of the node.

Furthermore, a change in memory access characteristics of each process is obtained by controlling the performance measuring means, and when assigning a time slice of the processor to each process, a length of the time slice to be assigned to each process is changed on the basis of the change in the memory access characteristics of each process that is being executed or can be executed on the computer.

If it is detected that there is a tendency for the memory access wait time ratio of a process in a time slice or the memory access size to decrease to a level lower than a predetermined threshold value or a threshold value determined by a scheduling function on the basis of memory access characteristics of each process, a length of the time slice of the process is changed to a larger value than the predetermined value.

After obtaining a change in a memory access size of each process by controlling the performance measuring means, start time of a time slice is set at different time for each process assigned to each processor in the computer system, with the result that as compared with a case where time slices are started simultaneously, a decrease in performance is prevented. The decrease in performance is caused by a total memory access size of processes being executed simultaneously, which has exceeded memory access performance of the computer.

In order to realize process scheduling like this on the basis of change in processor operation characteristics efficiently, a realized performance measurement system is characterized by the following: the processor has one or more performance measuring circuits comprising a pair of a performance measuring data register for counting the number of times a specific event has taken place from among a plurality of events that have taken place in the processor, and a performance measuring control register for indicating an event that should be measured by the performance measuring register; and by successively storing a value of the performance measuring data register in an area for performance measurement, which is provided in a memory of the computer, the performance measuring circuit can obtain a change in the specific event in a time slice.

One method comprises the steps of: recording processor operation characteristics of each process, which have been obtained by controlling the performance measuring means, on a file system; and when executing the process next time, selecting a processor, to which the process is assigned, with priority on the basis of processor operation characteristics of the process, which have been recorded on the file system. Even if a part of the processors does not have the performance measuring means, by using the processor having the performance measuring means, it is possible to select a processor, to which each process is assigned, with priority on the basis of the memory access characteristics that have been obtained when executing the process.

The process scheduling method described above can be applied easily not only to a standalone computer but also a computer cluster system in which a plurality of computers are connected via a network.

### BRIEF DESCRIPTION OF THE DRAWINGS

FIG. 1 is a schematic diagram of a computer cluster system according to a first embodiment of the present invention;

FIG. 2 is a configuration diagram of the computer cluster system according to the first embodiment of the present invention;

FIG. 3 is a diagram illustrating processor characteristic information according to the first embodiment of the present invention;

FIG. 4 is a diagram illustrating node characteristic information according to the first embodiment of the present invention;

FIG. 5 is a diagram illustrating cluster node characteristic information according to the first embodiment of the present invention;

FIG. 6 is a diagram illustrating process assignment information according to the first embodiment of the present invention;

FIG. 7 is a diagram illustrating a performance estimating method of each processor according to the first embodiment of the present invention;

FIG. 8 is a diagram illustrating process assignment information according to the first embodiment of the present invention;

FIG. 9 is a diagram illustrating estimated values of processor operation characteristics according to the first embodiment of the present invention;

FIG. 10 is a diagram illustrating a process scheduling method according to the first embodiment of the present invention;

FIG. 11 is a diagram illustrating estimated values of processor operation characteristics according to the first embodiment of the present invention;

FIG. 12 is a diagram illustrating process assignment information according to the first embodiment of the present invention;

FIG. 13 is a diagram illustrating memory access sizes at the time of simultaneous process switching according to a second embodiment of the present invention;

FIG. 14 is a diagram illustrating memory access sizes at the time of non-simultaneous process switching according to the second embodiment of the present invention; and

FIG. 15 is a diagram illustrating a performance measuring means according to a third embodiment of the present invention.

### DETAILED DESCRIPTION OF THE INVENTION

Hereinafter, preferred embodiments of the present invention will be described with reference to drawings.

[First Embodiment]

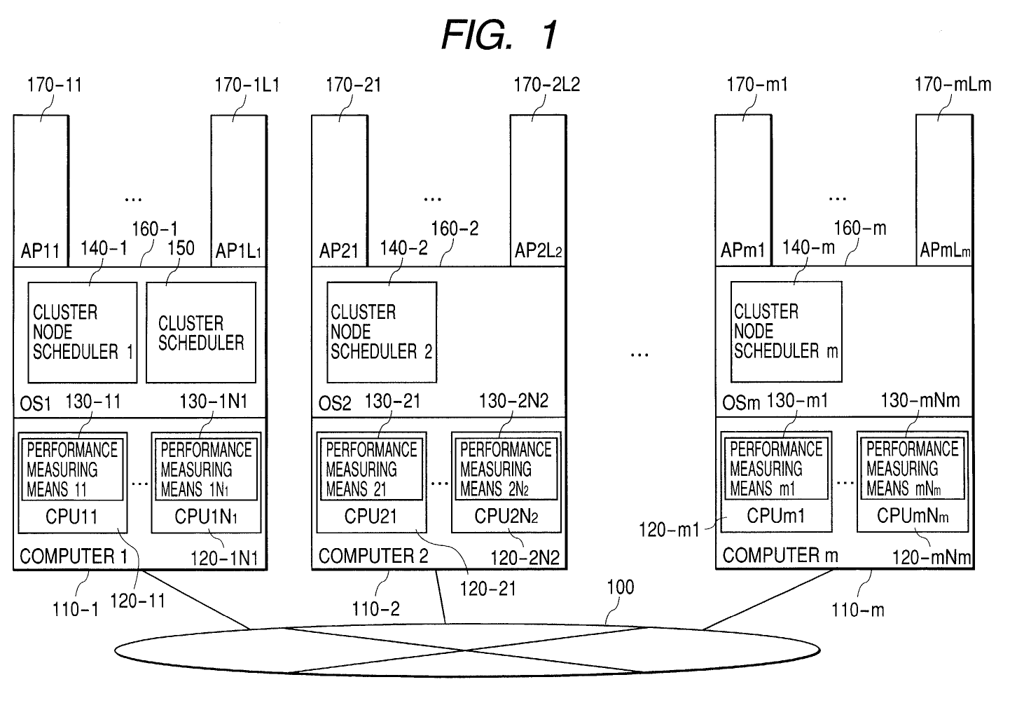

A first embodiment of the present invention will be described with reference to FIGS. 1 through 12 below.

FIG. 1 is a schematic diagram illustrating the relation among hardware and software components of a computer cluster system according to the present invention.

A computer cluster system shown in FIG. 1 has a configuration in which a computer 1 (110-1), a computer 2 (110-2), . . . , a computer m (110-m) are connected to one another via a network (100). On each of the computers (110-1, . . . , 110-m), one of operating systems (160-1, . . . , 160-m) and a plurality of processes from among processes (170-11 through 170-1L1, 170-21 through 170-2L2, . . . , 170-m1 through 170-mLm) operate. In this case, the process means an execution unit; to be more specific, an application program is divided into processes (execution units) that can be assigned to a processor. The process described in the present invention means a process in a broad sense, including a process that is generally called a thread or a lightweight process.

Each of the computers (110-1, . . . , 110-m) has processors 11 (120-11) through 1N1 (120-1N1), processors 21 (120-21) through 2N2 (120-2N2), . . . , processors m1 (120-m1 through 120-mNm). Each of the processors (120-11, . . . , 120-mNm) has performance measuring means (130-11, . . . , 130-mNm). The performance measuring means can measure various kinds of events taking place in the processor, such as memory access wait time, and a memory access size. Such performance measuring means are the publicly known technology, which is disclosed for example in “Pentium Pro Family Developer's Manual”, the second volume, Chapter 10, by Intel Corporation.

The operating systems (160-1, . . . , 160-m), which operate on each of the computers (110-1, . . . , 110-m), have a scheduling function that assigns each of the processes (170-11 through 170-1L1, . . . , 170-m1 through 170-mLm) to each of the processors (120-11 through 120-1N1, . . . , 120-m1 through 120-mNm). This embodiment is based on the assumption that when processing is started, or in the middle of the processing, each of the processes (170-11 through 170-mLm) can be migrated to an arbitrary processor from among the processors (120-11 through 120-mNm) before the migrated process is executed. A method for realizing such process migration is the publicly known technology, which is disclosed in “Distributed Operating System” Chapter 5, edited by Maekawa, and others, published by KYOURITSU SHUPPAN CO., LTD.

The scheduling function of each of the operating systems (160-1 through 160-m) performs dynamic load distribution, which is accompanied by process migration across the computers by cooperative operation described below. In this embodiment, in order to realize the above, the operating system 1 (160-1) of the computer 1 (110-1) is provided with a cluster scheduler (150); and the operating systems (160-1, . . . , 160-m) of the computers (110-1, . . . , 110-m) are provided with cluster node schedulers (140-1, . . . , 140-m).

The cluster scheduler (150) has a function of assigning each process, which is executed in the computer cluster system, to one of the computers (110-1 through 110-m). Upon determination of the assignment, in addition to general algorithm of the conventional process scheduler, process operation characteristics for each of the processes (170-11 through 170-mLm), which have been obtained using the performance measuring means (130-11 through 130-mNm) at the time of process execution, are taken into consideration.

The cluster node schedulers (140-1, . . . , 140-m) have a function of assigning each process, which has been assigned to a corresponding computer from among the computers (110-1, . . . , 110-m) by the cluster scheduler (150), to one of the processors (120-11 through 120-1N1, . . . , 120-m1 through 120-mNm) in the computer from among the computers (110-1, . . . , 110-m). Upon determination of the assignment, in addition to general algorithm of the conventional process scheduler, process operation characteristics for each of the processes (170-11 through 170-mLm), which have been obtained using the performance measuring means (130-11 through 130-mNm) at the time of process execution, are taken into consideration. In addition, the cluster node schedulers (140-1, . . . , 140-m) control the performance measuring means (130-11 through 130-1N1, . . . , 130-m1 through 130-mNm), which exist in each of the processors (120-11 through 120-1N1, . . . , 120-m1 through 120-mNm) on the corresponding computers (110-1, .. ., 110-m), and then obtain processor operation characteristics of the processors (120-11 through 120-1N1, . . . , 120-m1 to 120-mNm) when executing each of the processes (170-11 through 170-mLm). It is possible to exchange the processor operation characteristics with the cluster schedulers (150) in order to perform scheduling as a whole cluster based on the processor operation characteristics of each process. To be more specific, providing the cluster scheduler (150) with the processor operation characteristics of the processes (170-11 through 170-1L1, . . . , 170-m1 through 170-mLm) on the own computer (110-1, . . . , 110-m) by the cluster node schedulers (140-1, . . . , 140-m) permits the cluster scheduler (150) to perform process scheduling as a whole computer cluster system. On the other hand, giving the processor operation characteristics, which have been obtained when executing the process in the other computers (110-1, . . . , 110-m), at the time of process assignment to the computers (110-1, . . . , 110-m) by the cluster scheduler (150) permits the cluster node schedulers (140-1, . . . , 140-m) to determine assignment of a processor based on the processor operation characteristics.

In this embodiment, the cluster scheduler (150) exists in the operating system 1 (160-1). However, the present invention can be realized regardless of a position of the cluster scheduler (150) in the computer cluster system. The reason is that the cluster scheduler (150) and the cluster node scheduler (140-1 through 140-m) are also a kind of processes, and that inter-process communication in a computer, or across computers, is realized by the prior art. Therefore, for example, the present invention can also be realized by the following method: the cluster scheduler (150) is executed by a computer for scheduler use only; or a function of the cluster scheduler (150) itself is realized by distributing the function among a plurality of computers (110-1 through 110-m) on the computer cluster system.

In this embodiment, dynamic load distribution based on operation characteristics for each of the processes (170-11 through 170-mLm) becomes possible by the following processing: the cluster scheduler (150) and the cluster node schedulers (140-1, . . . , 140-m), which take charge of a scheduling function in each of the operating systems (160-1, . . . , 160-m) on each of the computers (110-1, . . . , 110-m), control the performance measuring means (130-11 through 130-1N1, . . . , 130-m1 through 130-mNm) in each processor to obtain the processor operation characteristics of each of the processes (170-11 through 170-1L1, . . . , 170-m1 through 170-mLm), and then assign each of the processes (170-11 through 170-mLm) to each of the processors (130-11 through 130-mNm) on the basis of the characteristics. Therefore, as compared with the conventional method that assigns processors (130-11 through 130-mNm) without taking the processor operation characteristics for each process into consideration, it is possible to realize better processor assignment. As a result, the performance of the computer cluster system can be improved.

A configuration of a computer system and its operation according to this embodiment will be described in detail below.

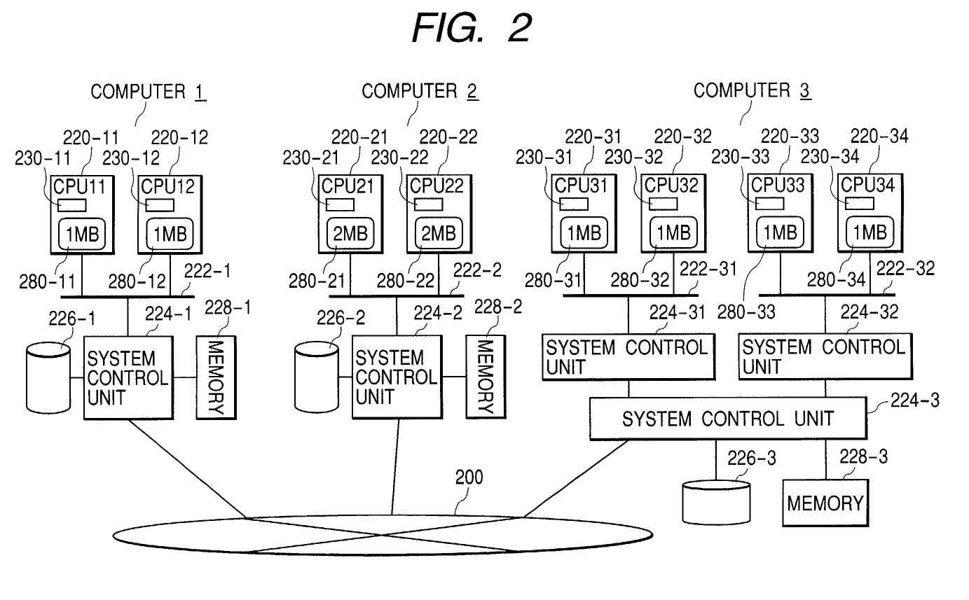

FIGS. 2 through 6 illustrate the configuration of the computer system, and information held by a cluster scheduler and a cluster node scheduler, according to this embodiment.

FIG. 2 illustrates a hardware configuration of a computer cluster system according to this embodiment.

The computer cluster system shown in FIG. 2 has a configuration in which the computers 1 through 3 are connected to one another via a network (200).

The computer 1 has a configuration in which a memory (228-1), a disk (226-1), and two processors (220-11, 220-12), which have cache memories (280-11, 280-12) of 1 MB respectively, are connected to one another through a system control unit (224-1). The processors (220-11, 220-12) share a processor bus (222-1). The computer 2 has a configuration in which a memory (228-2), a disk (226-2), and two processors (220-21, 220-22), which have cache memories (280-21, 280-12) of 2 MB respectively, are connected to one another through a system control unit (224-2). The processors (220-21, 220-22) share a processor bus (222-2). The computer 3 has a configuration in which a memory (228-3), a disk (226-3), and four processors (220-31, . . . , 220-34), which have cache memories (280-31, . . . , 280-34) of 1 MB respectively, are connected to one another through system control units (224-3, 224-31, 224-32). The two processors (220-31, 220-32) are connected to the system control unit (224-31) through a processor bus (222-31); and the two processors (220-33, 220-34) are connected to the system control unit (224-32) through a processor bus (222-32).

Each of the processors (220-11 through 120-34) has performance measuring means (230-11 through 230-34), each of which can obtain operation characteristics of the processor. In addition, the operating system (260-1), which operate on the computer 1, has a cluster scheduler (250); and each of operating systems (260-1 through 260-3) which operates on the computer 1 through 3 respectively, has the cluster node scheduler (240-1 through 240-3).

It is to be noted that instead of the configuration in which the performance measuring means (230-11 through 230-34) are provided on each of the processors (220-11 through 220-34), a configuration, in which they are provided in the system control units (224-1 through 224-32), are also possible. In this case, it is possible to measure values such as the number of memory access commands, which are issued to corresponding processor buses (222-1 through 222-32) by the processors (220-11 through 220-34), and to get information on system operation characteristics that is useful for process scheduling. Therefore, the present invention can also be applied to such a computer.

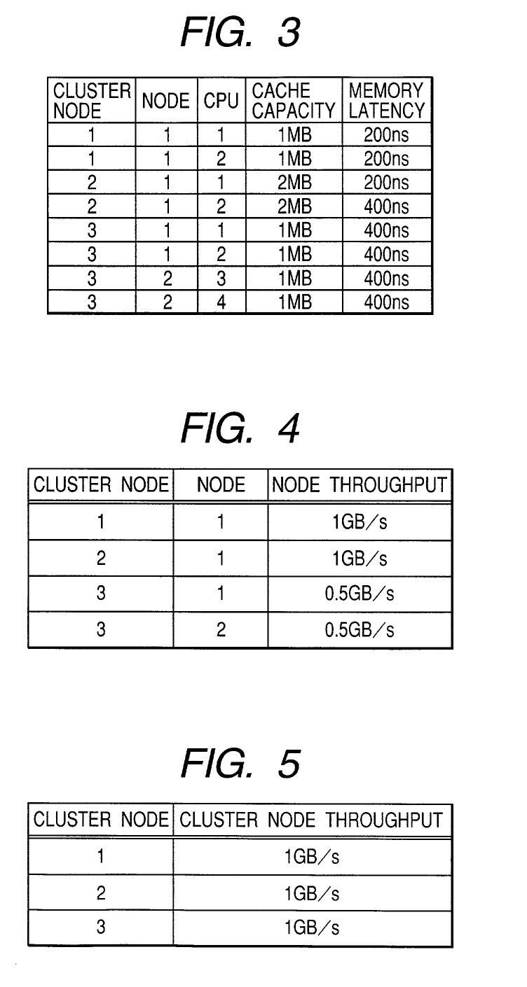

FIG. 3 illustrates processor characteristic information that is held by the cluster scheduler (250) and the cluster node schedulers (240-1 through 240-3). In this embodiment, the processor characteristic information includes a cluster node (computer) number, a node number in a computer, cache capacity of a processor indicated by a processor number, and memory access latency. The cluster node here means a processor configuration which is directly accessible to the same memory 228, whereas the node means a processor configuration which is controlled by the same operating system 260. For convenience of explanation, this embodiment is based on the assumption that operation frequency of a core part of the processors (220-11 through 220-34), the number of arithmetic logic units, and the like, are the same. Although they are not described in the processor characteristic information, it is also possible to describe the processor characteristic information so that they are included. In this case, process scheduling, which takes difference of the core part of the processors (220-11 through 220-34) into consideration, becomes possible. However, this will be supplemented properly below.

FIG. 4 illustrates node characteristic information that is held by the cluster scheduler (250) and the cluster node schedulers (240-1 through 240-3). In this embodiment, the node characteristic information includes a cluster node (computer) number, memory access throughput of a node indicated by a node number in a computer. For example, a node of (3, 1) (cluster node number, node number), that is to say, a node, which is configured to center on a system control unit (224-31) shown in FIG. 2, shows that the memory access throughput is 0.5 GB/s.

FIG. 5 illustrates cluster node characteristic information that is held by the cluster scheduler (250) and the cluster node schedulers (240-1 through 240-3). In this embodiment, the cluster node characteristic information includes memory access throughput of a cluster node indicated by a cluster node (computer) number.

As described above, the characteristic information shown in FIGS. 3 through 5 is information held by the operating cluster scheduler (250) and the cluster node schedulers (240-1 through 240-3), which are in the computer cluster system. As one method, it is possible to use the following method: information shown in FIGS. 3 through 5 is saved in a file system on a disk; and when starting the computer cluster system, the operating systems (260-1 through 260-3) read the file to pass it to the cluster scheduler (250) and the cluster node schedulers (240-1 through 240-3). As another method, it is also possible to use the following method: the cluster node schedulers (240-1 through 240-3) perform a bench mark test that measures characteristic information shown in FIGS. 3 through 5 when starting the computer cluster system or with appropriate timing. As such a bench mark test, the following prior art can be applied: SPEC CPU benchmark relating to performance characteristic of a processor (http://www.spec.org); STREAM benchmark relating to memory access throughput (http://www.cs.virginia.edu/stream); lmbench relating to memory access latency (http://reality.sgi.com/lm/lmbench); and the like.

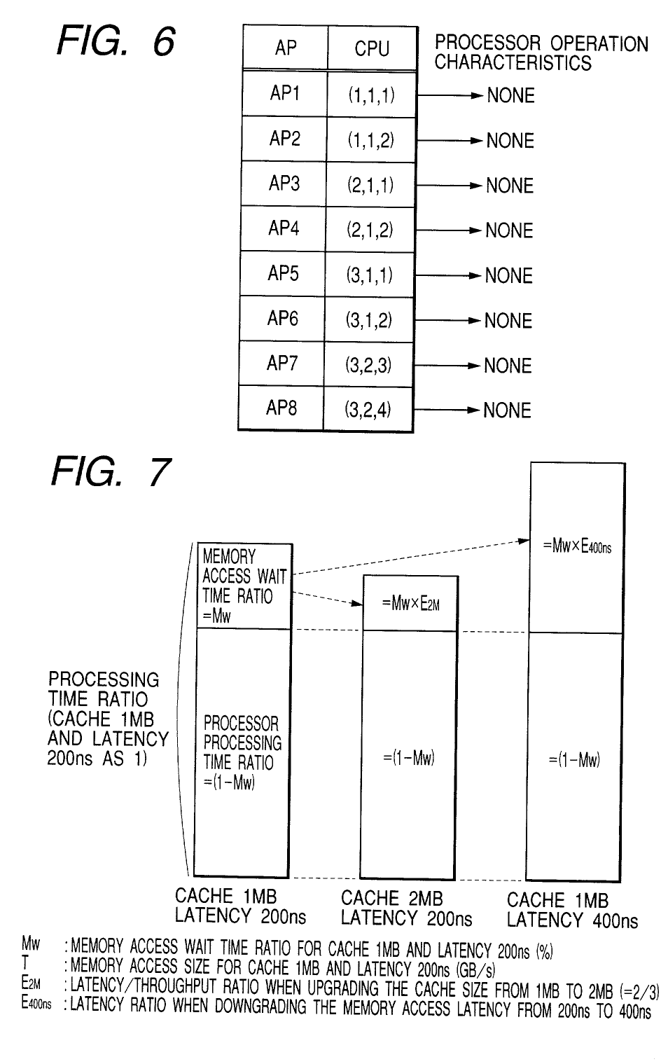

FIG. 6 is process assignment information that is held by a cluster scheduler. According to FIG. 6, at present, processes AP1, AP2 are assigned to a processor (1, 1, 1) (processor 220-11 in FIG. 2) and a processor (1, 1, 2) (processor 220-12 in FIG. 2) of the computer 1, respectively; processes AP3, AP4 are assigned to a processor (2, 1, 1) (processor 220-21 in FIG. 2) and a processor (2, 1, 2) (processor 220-22 in FIG. 2) of the computer 2, respectively; and processes AP5 through AP8 are assigned to a processor (3, 1, 1) (processor 220-31 in FIG. 2), a processor (3, 1, 2) (processor 220-32 in FIG. 2), a processor (3, 2, 3) (processor 220-33 in FIG. 2), and a processor (3, 2, 4) (processor 220-34 in FIG. 2), of the computer 3, respectively.

Each of the cluster node schedulers (240-1 through 240-3) holds only information about the processes during operation on its own computer, from among the information in FIG. 6. To be more specific, the computer 1 holds information described in lines of AP1, AP2 in FIG. 6; the computer 2 holds information described in lines of AP3, AP4 in FIG. 6; and the computer 3 holds process assignment information of AP5 through AP8 in FIG. 6. Operation for assigning a process to each of the processors (220-11 through 220-34) in a computer is performed by each of the cluster node schedulers (240-1 through 240-3) as described above. When process assignment is changed for the processors (220-11 to 220-34) in the computer, the cluster node schedulers (240-1 through 240-3) notify the cluster scheduler (250) of new assignment so that the process assignment information held by the cluster node schedulers (240-1 through 240-3) agrees with the process assignment information held by the cluster scheduler (250).

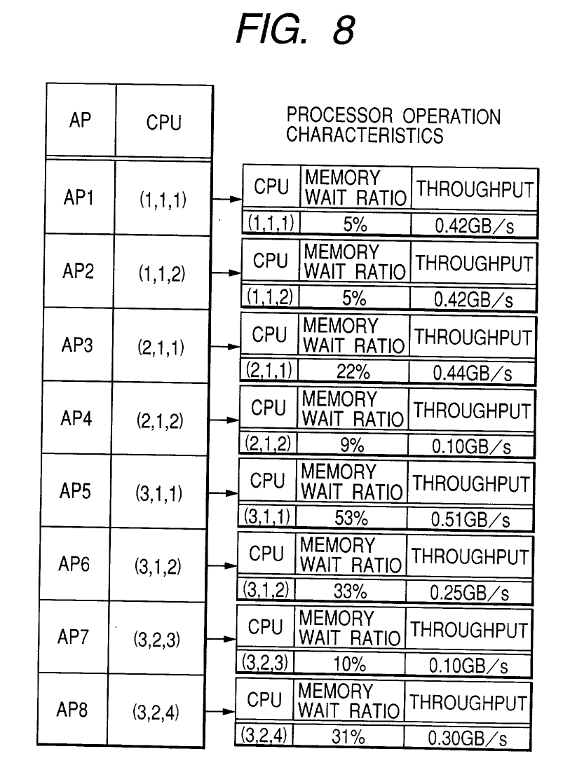

The processor operation characteristics, which have been measured for each process by the performance measuring means (230-11 through 230-34) shown in FIG. 1, can be registered in the process assignment information. (FIG. 6 shows a state in which a process is assigned on the computer cluster system for the first time, and also shows a state in which processor operation characteristics are not registered.) FIGS. 7 through 12 illustrate a process scheduling method and its operation.

FIG. 7 illustrates a performance estimating method used when a process is operated by three kinds of processors existing on the computer cluster system in FIG. 2. The performance estimating method in FIG. 7 shows a method for determining performance estimation values including a memory access wait time ratio in other processors, and memory access throughput with reference to processors (220-11, 220-12) having a cache of 1 MB and memory access latency of 200 ns.

This is based on the assumptions that process processing time for the processors (220-11 through 220-12) having a cache of 1 MB and latency of 200 ns is 1, and that the memory access wait time ratio is Mw. In this case, processing time ratio of the processor excluding memory access wait time is equivalent to (1−Mw).

In the first place, in a case where the same process is executed using the processor (one of 220-21 through 220-22) having a cache of 2 MB and memory access latency of 200 ns, a performance estimation value is considered. Because the cache capacity increases from 1 MB to 2 MB, a cache hit ratio is improved, resulting in decrease in the number of memory accesses, which causes memory access wait time to be reduced. In addition, as a result of the decrease in the number of memory accesses, memory access throughput requested by the process is also reduced. This embodiment is based on the assumption that the ratio of the memory access wait time and the memory access throughput is the same value E_{2M} (=⅔).

As a result of the above, if the cache is 2 MB and the latency is 200 ns, processor processing time is (1 −Mw), and a memory access wait time ratio is Mw×E_{2M}. Therefore, if the cache is 2 MB and the latency is 200 ns, memory access wait time Mw′ is equivalent to Mw×E_{2M}/{(1−Mw)+Mw×E_{2M}}. In addition, if the cache is 2 MB and the latency is 200 ns, memory access throughput T′ is equivalent to T×E_{2M}/{(1−MW)+Mw×E_{2M}}, using the memory access throughput T at the time of the cache of 1 MB and the latency of 200 ns. In this case, division by the term of { } reflects that a memory access size per unit time increases as processing time of a process is decreased.

In a similar manner, in the case of the processors (220-31 through 220-34) having the cache of 1 MB and the memory access latency of 400 ns, values can be calculated as shown in FIG. 7, using latency ratio E₄₀₀ₙₛ (=2) resulting from an increase in the memory access latency from 200 ns to 400 ns. In this case, in a numerator used when calculating memory access throughput T″, the reason why T is not multiplied by E₄₀₀ₙₛ is that because the cache capacity is the same, the cache hit ratio is also the same.

Using this performance estimating method enables estimation of processing performance in the case of other processors, on the basis of the processor operation characteristics that have been obtained using one of the processors on the computer cluster system shown in FIG. 2.

It is to be noted that if frequency of a core part of the processor, the number of arithmetic logic units, etc. are different, using a coefficient, which increases and decreases processor processing time, enables estimation of performance in a manner similar to the above.

An outline of process scheduling operation according to this embodiment will be described as below.

(1) Each of the processors (220-11 through 220-12, . . . , 220-31 through 220-34) executes an assigned process. At this time, the cluster node schedulers (140-1, . . . , 140-3) control the performance measuring means (230-11 through 230-12, . . . , 230-31 through 230-34), which are possessed by the processors (220-11 through 220-12, . . . , 220-31 through 220-34) in the own computer respectively, to measure processor operation characteristics of each process.

(2) Each of the cluster node schedulers (240-1, . . . , 240-3) sends the processor operation characteristics, which have been measured in (1), to the cluster scheduler (250).

(3) The cluster scheduler (250) selects a processor, to which each of the processes (220-11 through 220-34) is assigned, on the basis of the processor operation characteristics of each process.

(4) Return to (1).

The above (1) through (4) will be detailed with reference to FIGS. 8 through 12 below.

(1) Measure Processor Operation Characteristics

The cluster scheduler (250) and the cluster node schedulers (240-1 through 240-3) assign each process to the processor (one of 220-11 through 220-34) according to FIG. 6. In the operation, the cluster scheduler (250) sends process assignment information (FIG. 6) about a process, which will be executed in the computer, to each of the cluster node schedulers (240-1 through 240-3). Each of the cluster node schedulers (240-1 through 240-3) assigns each process to each of the processors (220-11 through 220-34) in the computer on the basis of the process assignment information that has been received from the cluster scheduler (250).

Immediately before assigning each process to each of the processors (220-11 through 220-34), the cluster node schedulers (240-1 through 240-3) control the performance measuring means (230-11 through 230-34) of the processor s to start measurement of processor operation characteristics. Then, after a lapse of a time slice interval that is prescribed by the operating system (260-1 through 260-3), the cluster node scheduler controls the performance measuring means (230-11 through 230-34) to stop the measurement of processor operation characteristics before obtaining the processor operation characteristics.

(2) Send Processor Operation Characteristics to Cluster Scheduler (250)

Each of the cluster node schedulers (240-1 through 240-3) sends the processor operation characteristics, which have been obtained in (1), to the cluster scheduler (250). In response to them, the cluster scheduler (250) adds the processor operation characteristics to an entry of each process of the process assignment information. FIG. 8 illustrates a state in which the processor operation characteristics of each process have been obtained as a result of processor assignment on the basis of the process assignment information shown in FIG. 6. Processor operation characteristics corresponding to each process are shown by a processor number, a memory access wait time ratio (memory wait ratio in the figure), a memory access size of a process (throughput in the figure).

(3) Assign a Process to a Processor

The cluster scheduler (250) determines new processor assignment on the basis of the processor operation characteristics for each process shown in FIG. 8.

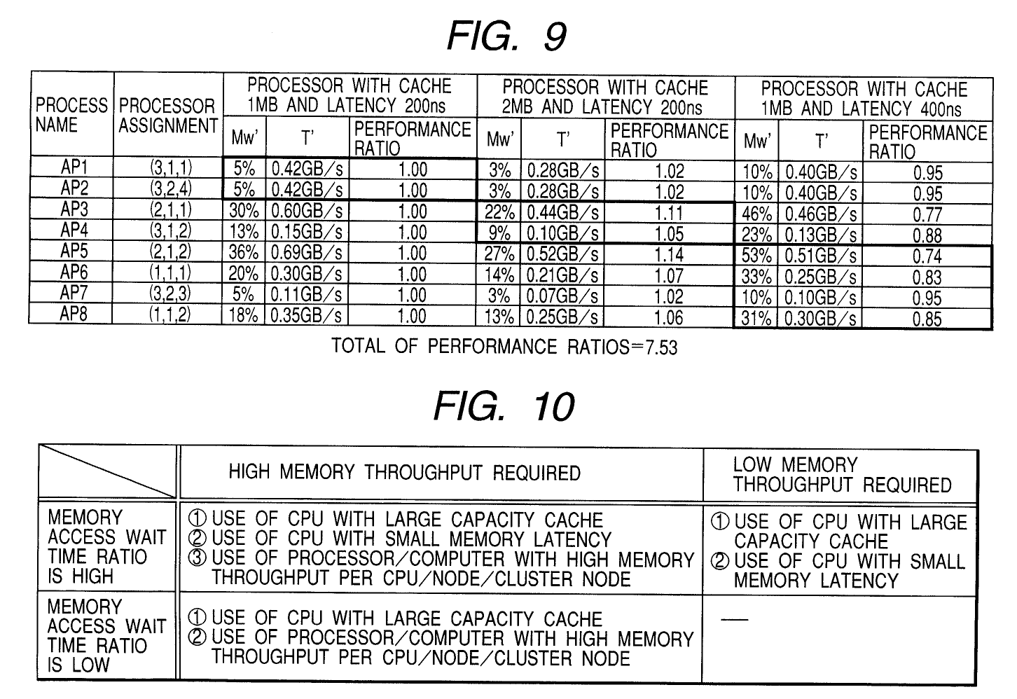

FIG. 9 illustrates processor operation characteristics estimated when operating each process using each processor by means of the performance estimating method in FIG. 7 on the basis of the processor operation characteristics for each process shown in FIG. 8. It is to be noted that numerical values in thick frames are actual measurements.

FIG. 10 illustrates a process scheduling method in this embodiment.

Processing time of a process is equivalent to the sum of processor processing time and memory access wait time as shown in the description in FIG. 6. Therefore, in order to shorten the processing time of a process to improve processing performance, it is necessary to minimize a memory access wait time ratio. In this embodiment, the memory access wait time ratio is minimized using three kinds of methods as shown below.

(i) Use a Processor Having a Large-Capacity Cache

A cache hit ratio is improved by executing a process using a processor having a large-capacity cache, with the result that both of an effect of suppressing memory access latency and an effect of reducing a memory access size are provided. The memory access wait time of the processor can be reduced by the effect of suppressing memory access latency. In addition, as a result of the reduction in the memory access size, a frequency of an access request beyond performance of the processor, a node, a cluster node is decreased, which prevents the memory access wait time from increasing.

(ii) Use a Processor Having Short Memory Access Latency

Memory access latency is reduced by executing a process using a processor having short memory access latency. As a result, memory access wait time of the processor can be reduced.

(iii) Use a Processor/Computer Having High Memory Access Throughput Per Processor/Node/Cluster Node

If an access request beyond performance of a processor, that of a node, or that of a cluster node is issued, the wait time which occurs in the processor, the node, or the cluster node causes memory access wait time to be increased. In this case, executing a process using a processor/computer having high memory access throughput enables a reduction in the memory access wait time.

A memory access wait time ratio is minimized according to a process scheduling method in FIG. 10 on the basis of expected values of processor operation characteristics in FIG. 9 as below.

(1) The cluster scheduler (250) assigns a process to processor in decreasing order of capability of reducing a memory access wait time ratio one by one. If the processors used in this embodiment are ranked in decreasing order of capability of reducing a memory access wait time ratio, they are the processors (220-21, 220-22) having a cache of 2 MB and memory access latency of 200 ns, the processors (220-11, 220-12) having a cache of 1 MB and memory access latency of 200 ns, and the processors (220-31 through 220-34) having a cache 1 MB and memory access latency 400 ns.

(2) At the time of assignment of the processors (220-21, 220-22) having a cache of 2 MB and memory access latency of 200 ns, the cluster scheduler (250) compares expected values and actual measurements of processor operation characteristics (FIG. 9) of each of the processes AP1 through AP8 in these processors, and then selects the processes AP3, AP5 having the highest memory access wait time ratio. At this time, the selection is made so that in addition to the memory access wait time ratio, expected values and actual measurements of memory access sizes for all processes, which are assigned to the computer, do not exceed memory access throughput of the computer, which is shown in characteristic information on the cluster node in FIG. 5, wherever practicable.

(3) At the time of assignment of the processors (220-11, 220-12) having a cache of 1 MB and memory access latency of 200 ns, the cluster scheduler (150) compares expected values and actual measurements of processor operation characteristics (FIG. 9) of each of the processes except AP3 and AP5 in these processors, and then selects the processes AP6, AP8 having the highest memory access wait time ratio. At this time, the selection is made so that in addition to the memory access wait time ratio, expected values and actual measurements of memory access sizes for all processes, which are assigned to the computer, do not exceed memory access throughput of the computer, which is shown in characteristic information on the cluster node in FIG. 5, wherever practicable.

(4) In the case of the processors (220-31 through 220-34) having a cache of 1 MB and memory access latency of 400 ns, AP1, AP2, AP4, AP7 are selected; in other words, the processes, which have been selected in (2) and (3), are excluded for the selection. At this time, the selection is made so that in addition to the memory access wait time ratio, expected values and actual measurements of memory access sizes for all processes, which are assigned to the computer, do not exceed memory access throughput of the computer, which is shown in characteristic information on the cluster node in FIG. 5, wherever practicable.

(5) The cluster scheduler (250) allocates a process to each of the cluster node schedulers (240-1 through 240-3) of the computers on the basis of the selection in (2) through (4).

(6) Each of the cluster node schedulers (240-1 through 240-3) assigns each process, which has been allocated by the cluster scheduler (250) in (5), to each of the processors (220-11 through 220-34) in the own computer. In the computer 3 having a plurality of nodes, when assigning a process to each of the processors (220-31 through 220-34), memory access performance per node shown in FIG. 4 is taken into consideration. To be more specific, when assigning the processes AP1, AP2, AP4, AP7 to each of the processors (220-31 through 220-34), AP1, AP2 are assigned to different nodes, considering that memory access throughput per node is 0.5 GB/s.

In this embodiment, for convenience of explanation, process scheduling is performed on the basis of only processor operation characteristics of each process. In an actual operating system, priority is given to each process in consideration of wait time until execution, and the like. A process having higher priority is selected and executed. In the present invention, changing priority of process assignment to each processor on the basis of processor operation characteristics of each process enables easy implementation in existing process scheduling algorithm.

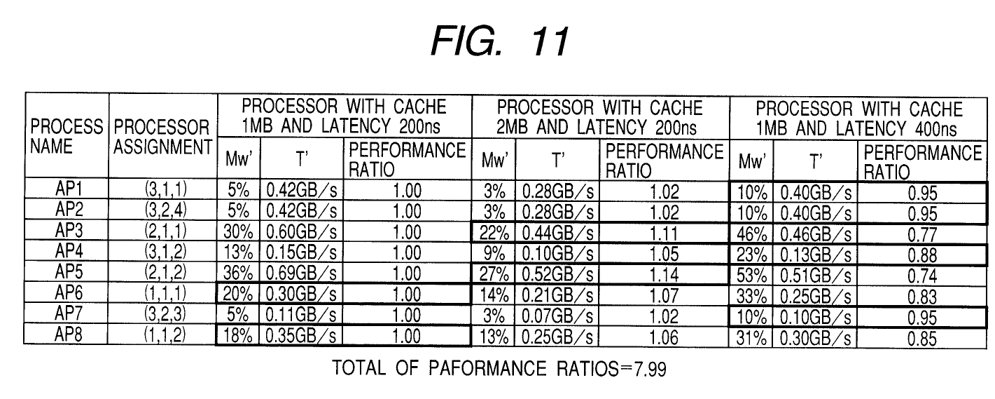

FIG. 11 illustrates a result obtained when processor assignment of each process in FIG. 9 is executed again by process scheduling operation shown in (1) through (6) described above. As a result of the execution, if the processor operation characteristics of each process are the same as those by the performance estimating method shown in FIG. 7, it is found out that process processing performance is improved from 7.53 times to 7.99 times for one processor having a cache of 1 MB and memory access latency of 200 ns.

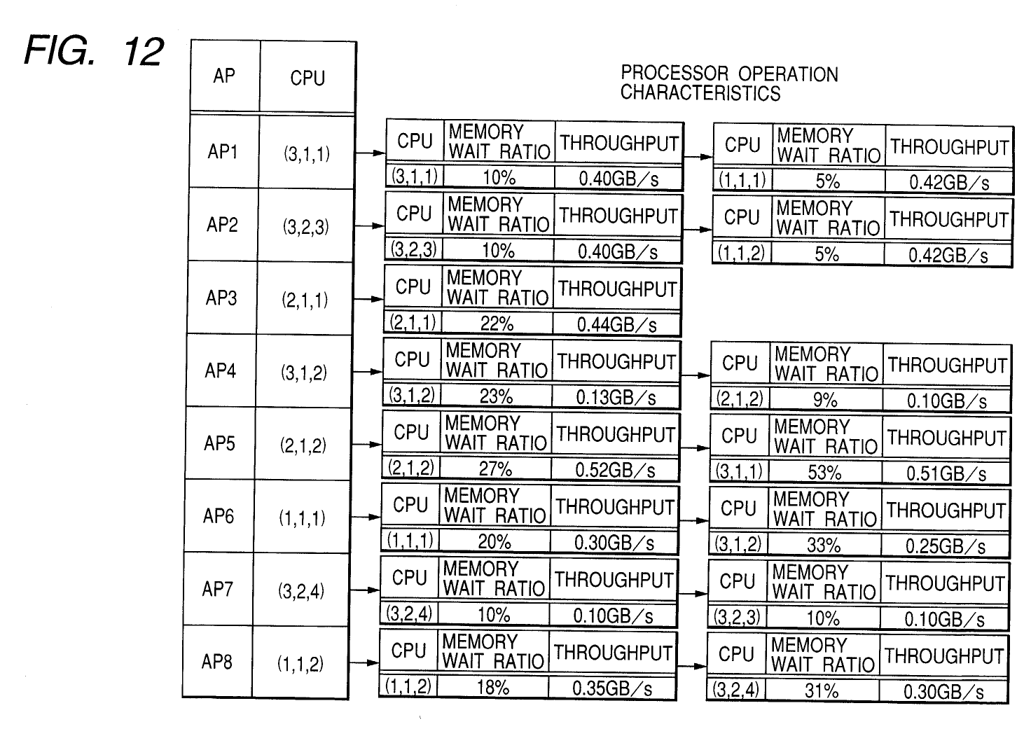

FIG. 12 illustrates a state in which after measuring processor operation characteristics at the time of process execution on the basis of new processor assignment, a result of the measurement is added to process assignment information in FIG. 8. In this manner, as processing proceeds, processor operation characteristics measured when each process is executed using different processors are registered in the process assignment information. As a result, thereafter process scheduling can be performed on the basis of the actual measurements of the processor operation characteristics.

In addition, process scheduling can be performed suitably on the basis of formerly obtained execution result, when starting process execution, by the following steps: when a process ends or when the computer cluster system is shut down, storing the processor operation characteristics, which are registered in the process assignment information, in a file system; and reading the processor operation characteristics, which have been stored in the file system, when executing a process.

Moreover, even if some processors on the computer cluster system do not have the performance measuring means (230-11 through 230-34), the cluster scheduler (250) and the cluster node schedulers (240-1 through 240-3) can estimate process processing performance of these processors on the basis of the processor operation characteristics obtained when a process is executed on a processor having the performance measuring means (230-11 through 230-34). As a result, the cluster scheduler (250) and the cluster node scheduler (240-1 through 240-3) can preferably perform process scheduling on the basis of the estimation.

The above is the first embodiment of the present invention.

The dynamic load distribution based on operation characteristics for each of the processes (170-11 through 170-mLm) becomes possible by the following processing: in the computer cluster system having one or more computers, the cluster scheduler (250) and the cluster node schedulers (240-1, . . . , 240-3), which take charge of a scheduling function in the operating systems (260-1, . . . , 260-3) of each computer, control the performance measuring means (230-11 through 230-12, . . . , 230-31 through 230-34) in each of the processors (220-11 through 220-12, 220-31 through 220-34) to obtain processor operation characteristics of each of the processes (170-11 through 170-1L1, . . . , 170-m1 through 170-mLm), and then assign each of the processes (170-11 through 170-mLm) to each of the processors (220-11 through 220-34) based on the characteristics. Therefore, as compared with the conventional method that assigns the processors (220-11 through 220-34) without taking the processor operation characteristics for each of the processes (170-11 through 170-mLm) into consideration, it is possible to realize better processor assignment. As a result, performance of the computer cluster system can be improved.

[Second Embodiment]

A second embodiment of the present invention will be described below.

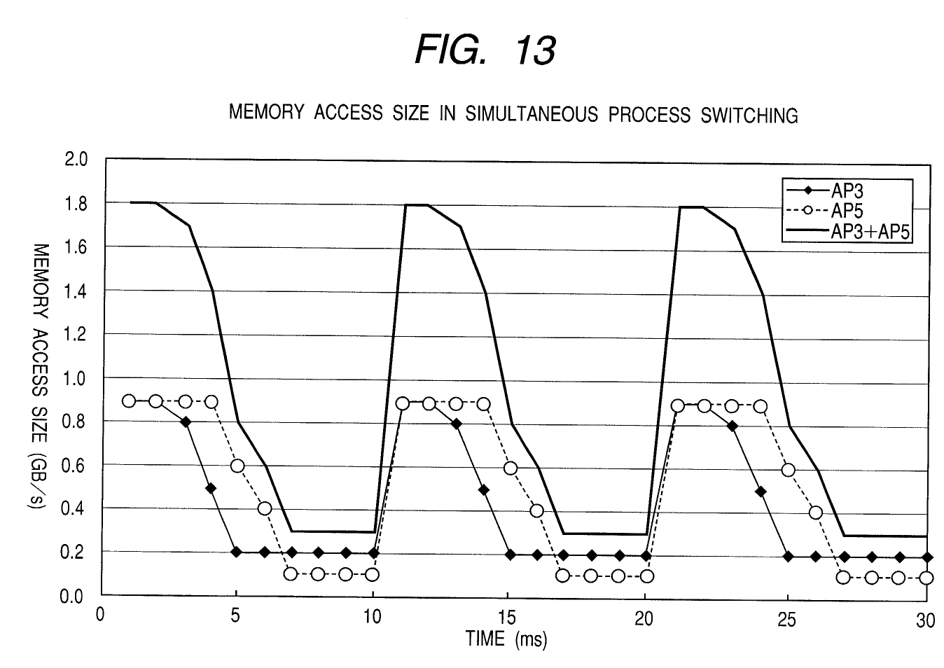

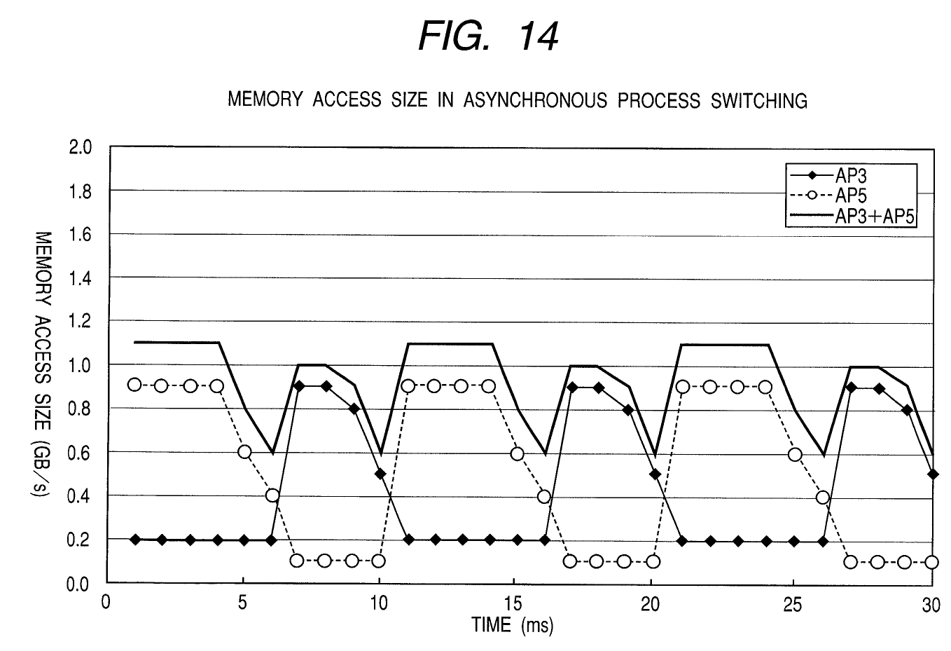

Because the second embodiment is a modification of the first embodiment, only points of difference will be described with reference to FIGS. 13 and 14.

This embodiment differs from the first embodiment in the following point: when the cluster node scheduler (240-1 through 240-3) controls the performance measuring means (230-11 through 230-34) to obtain a change in a memory access size, and then assigns processing time of a processor (time slice) to each process using this, start time of the time slice and a length of the time slice are optimized.

This embodiment shows optimization of time slice used when four processes (processes AP3, AP5 having the processor operation characteristics shown in FIG. 12, and processes AP3′, AP5′ having the same processor operation characteristics as those of AP3, AP5 respectively) are executed on the computer 2 according to the first embodiment.

On the computer 2, AP3 and AP3′ are executed on the processor (220-21) alternately, and AP5 and AP5′ are executed on the processor (220-22) alternately. As shown in FIG. 12, the process AP3 (and AP3′) has memory access size of 0.43 GB/s; and the process AP5 (and AP5′) has memory access size of 0.5 GB/s. This memory access size is actually a mean value in the time slice in which the operating system (260-2) has assigned the processors (220-21, 220-22) to these processes.

FIG. 13 illustrates a change in a memory access size found when two processors on the computer 2 (220-21 through 220-22) switch between AP3 and AP3′, and between AP5 and AP5′ simultaneously in time slice of 10 ms. An average memory access size of AP3 and AP3 is 0.43 GB/s. However, the change in a memory access size ranges from 0.2 GB/s to 0.9 GB/s. An average memory access size of AP5 and AP5′ is 0.5 GB/s. However, the change in a memory access size ranges from 0.1 GB/s to 0.9 GB/s. The memory access size is high immediately after a process is assigned to the processor (one of 220-21 through 220-22); and the memory access size decreases as time elapses after the process assignment. The reason why there is such a tendency is that just for a little while after the process is assigned to the processor (one of 220-21 through 220-22), data, which is used by the process, does not exist in the cache (280-21 through 280-22) in the processor, whereas as the processing proceeds, the data, which is used by the process, will be registered in the cache (280-21 through 280-22). After that, while other processes are executed, the data, which has been registered by the process, is gradually moved outside the cache (280-21 through 280-22). In FIG. 13, when executing AP3 and AP3′, or AP5 and AP5′, alternately, a memory access size is large immediately after the processes are switched. However, after a lapse of 5 ms after the processes are switched, the memory access size decreases.

When process switching by the processor (220-21) and the processor (220-22) are executed simultaneously, a peak period of the memory access size of AP3 and AP3′, and that of AP5 and AP5′, overlap one another. Therefore, as shown in FIG. 13, memory access of maximum 1.8 GB/s is required. On the other hand, because the maximum memory access throughput of the computer 2 is 1.0 GB/s (FIGS. 4 and 5), a part of process processing performance which exceeds this maximum memory access throughput, decreases.

In order to prevent the decrease in process processing performance, timing of process switching of the processor (220-21) and the processor (220-22) is shifted so that the peak periods of memory access size for AP3 and AP3′, and for AP5 and AP5′, do not overlap one another. FIG. 14 illustrates a state in which the peak periods of memory access size for AP3 and AP3′, and for AP5 and AP5′, could be shifted, with the result that a requested memory access size is 1.1 GB/s at the maximum. This shows that the requested memory access size can be reduced nearly to the maximum memory access throughput of the computer 2. It is to be noted that concerning a period of time by which process switching timing is shifted, a method, in which the process switching timing is shifted by S/P for time slice interval S and number of processes P, can be considered as one example. In addition, the following method can also be considered: shifting process switching timing gradually to calculate the maximum memory access size for each timing; and selecting a shifted process switching timing that has the minimum memory access size.

Moreover, a method, in which a time slice is lengthened in order to reduce an average memory access size of the processes, can also be considered. For example, in the case of the processes AP3 and AP3′ in FIG. 13, after a lapse of 5 ms after the processes are switched, data, which is required by the process, exists substantially in the cache. As a result, a memory access size after a lapse of 5 ms after the processes are switched becomes 0.2 GB/s. Therefore, if the time slice is lengthened to 20 ms, an average memory access size is 0.32 GB/s (={0.43 GB/s×10 ms+0.2 GB/s×10 ms}/20 ms). Thus, concerning the process of which an average memory access size is high, lengthening a time slice can reduce the average memory access size.

The above is the second embodiment of the present invention.

In this embodiment, according to the first embodiment, when the cluster node schedulers (240-1 through 240-3) control the performance measuring means (230-11 through 230-34) to obtain a change in a memory access size, and then assign a time slice of the processor to each process using the change, start time of the time slice and a length of the time slice are optimized. This produces an effect of preventing a decrease in performance; in this case, the decrease in performance is caused by issued memory access requests that exceed the maximum memory access throughput of a node or a cluster node, resulting from the overlapped peak periods of the memory access size of the processes Moreover, lengthening a time slice can reduce an average memory access size, which produces an effect of preventing a decrease in performance caused by concentration of memory access.

[Third Embodiment]

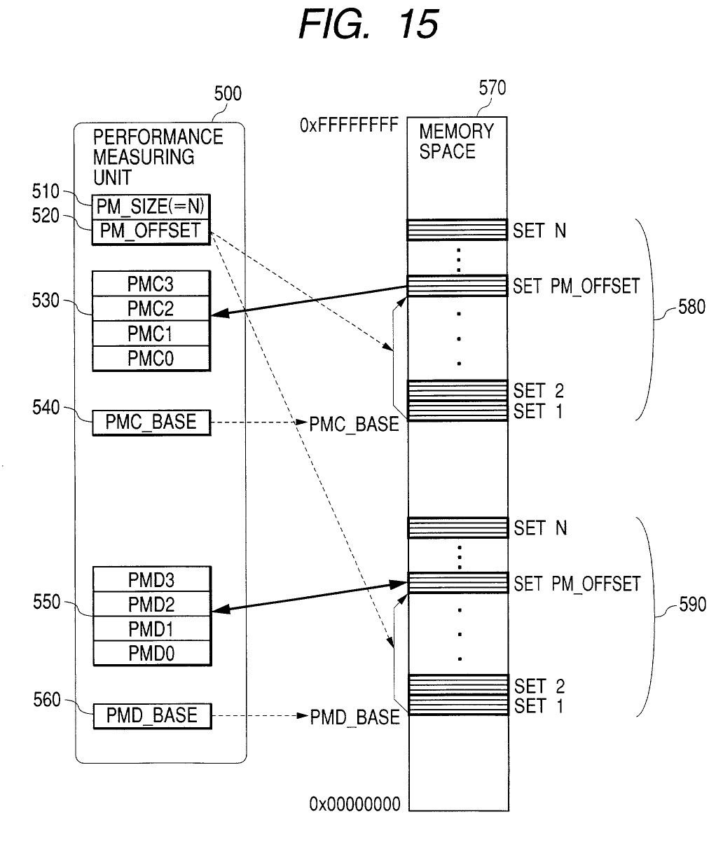

A third embodiment of the present invention will be described with reference to FIG. 15.

The third embodiment shows a configuration of the performance measuring means according to the second embodiment. Therefore, only this part will be described.

In the second embodiment, the performance measuring means (230-11 through 230-34) are required to obtain a change in a memory access size in a time slice. Therefore, on the assumption that the time slice is 10 ms, it is necessary to provide a plurality of sample points in the time slice of 10 ms. This embodiment shows a configuration of a performance measuring means that can obtain performance data efficiently at short sample intervals.

FIG. 15 illustrates a configuration of the performance measuring means according to this embodiment.

The performance measuring means in FIG. 15 is configured to comprise the following: a performance measuring unit (500) that is provided in a processor or a system control circuit; a memory area for performance measurement control (580) that is reserved in a memory space (570); and a memory area for performance measurement data (590).

The performance measuring unit (500) comprises the following: a performance measuring data register (550) for counting the number of events that take place in a processor or a system control circuit; a performance measuring control register (530) for selecting an event, which will be counted in the performance measuring data register (550), from among events that can be counted in the processor or the system control circuit; a PMC_BASE register (540) that indicates a base address of the memory area for performance measurement control (580); a PMD_BASE register (560) that indicates a base address of the memory area for performance measurement data (590); a PM_SIZE register (510) that indicates the number of pairs of the performance measuring control register (530) and the performance measuring data register (550), which can be stored in a memory area for performance measurement; and a PM_OFFSET register (520) that indicates a pair of the performance measuring control register (530) and the performance measuring data register (550), which are currently used in the memory area for performance measurement.

In this embodiment, the following processing is performed: reading settings for performance measurement from a position, which is indicated by the PM_OFFSET register (520), in the memory area for performance measurement control (580); setting the settings in the performance measuring control register (530); counting an event, which is specified by the settings, using the performance measuring data register (550); after a lapse of a predetermined period of time, storing the counted value, which has been counted using the performance measuring data register (550), in a position, which is indicated by the PM_OFFSET register (520), in the memory area for performance measurement data (590); and incrementing the PM_OFFSET register (520) before proceeding to the next count. Realizing the processing described above without intervention of an operating system, etc. enables a reduction in overhead for controlling the performance measuring means by software. As a result, the performance measuring means, which can obtain performance data efficiently at short sample intervals, is provided.

The operation of the performance measuring unit (500) will be described in detail below.

(1) Setting of the Performance Measuring Control Register (530)

Settings for performance measurement are read from the memory area for performance measurement control (580), and are set in the performance measuring control register (530).

This embodiment is based on the assumption that the performance measuring control register (530) comprises four registers, each of which has a length of 8 bytes. At this time, settings, which are read in (1), are stored in a memory area having a length of 32 bytes, which starts from an address indicated by a PMC_BASE register value+a PM_OFFSET register value ×32 bytes. The performance measuring unit (500) reads the data, and sets the data in the performance measuring control register (530).

(2) Setting of the Performance Measuring Data Register (550)

In this embodiment, there are two ways of count operation of the performance measuring means as follows:

The value of the performance measurement data, which has been counted before this time, is read from the memory area for performance measurement data (580) to set the value in the performance measuring data register (550). This embodiment is based on the assumption that the performance measuring data register (550) comprises four registers, each of which has a length of 8 bytes. At this time, the performance measurement data value, which are read, are stored in a memory area having a length of 32 bytes, which starts from an address indicated by a PMD_BASE register value+a PM_OFFSET register value×32 bytes. The performance measuring unit (500) reads the data, and sets the data in the performance measuring data register (550).

This enables sampling of the number of times an event has taken place, which has been set in the corresponding performance measuring control register (530), during a comparatively long period of time. For example, if 400 kinds of events (PM_SIZE=100) are obtained at switching intervals of 1 ms during process operation for 60 seconds, all settings are processed in 100 ms. Therefore, it is possible to perform sampling 600 times for each event. Thus, increasing the number of times of sampling enables accurate measurement of the number of times each of several hundred events has taken place using several pairs of performance measuring registers. Such a measurement method is the prior art shown in “Performance Characterization of the Pentium Pro Processor, In Proceedings of the Third International Symposium on High-Performance Computer Architecture”, page 288-297, February 1997 by D. Bhandarkar and others. In this paper, a performance measuring means of the Pentium Pro processor is controlled by software, and settings of a performance measuring register is switched at intervals of five seconds to measure performance. If the performance measuring means in the embodiment of the present invention is used, settings of the performance measuring register can be switched without intervention of software, which can shorten a switching interval to a large extent.

The performance measuring data register (550) is set at “0” before starting addition. This enables counting of the number of times an event has taken place during the period.

Two ways of operation described above can be used properly according to a purpose of performance measurement.

(3) Measure Performance

The number of times an event has taken place, which is set in the performance measuring control register (530), is counted in the performance measuring data register (550).

(4) Store a Value of the Performance Measuring Data Register (550) in the Memory Area for Performance Measurement Data (590)

After a lapse of a predetermined performance measurement interval, a value of the performance measuring data register (550) is stored in a position, which is indicated by a corresponding address (PMD_BASE register value+PM_OFFSET register value×32 B) , in the memory area for performance measurement data (590).

(5) Increment PM_OFFSET Register (520)

The PM_OFFSET register (520) is incremented so that the next performance measuring register in the memory area for performance measurement is pointed. In this case, when a value of the PM_OFFSET register (520) becomes larger than that of the PM_SIZE register (510), the PM_OFFSET register (520) is reset to “0”.

The above is the third embodiment of the present invention.

In the third embodiment, the performance measuring unit (500) performs the following processing: reading settings for performance measurement from the memory area for performance measurement control (580) to set the settings in the performance measuring control register (530); counting an event, which is specified by the setting, using the performance measuring data register (550); and after a lapse of a predetermined period of time, storing the counted value, which has been counted using the performance measuring data register (550), in the memory area for performance measurement data (590). The performance measuring unit (500) performs the processing while switching the processing for each entry in the memory area for performance measurement one by one. This enables reduction in overhead for controlling the performance measuring means by software. As a result, the performance measuring means, which can obtain performance data efficiently at short sample intervals, is provided.

According to the present invention, in the computer cluster system having one or more computers, dynamic load distribution on the basis of operation characteristics for each process becomes possible by the following: a cluster scheduler and a cluster node scheduler, which take charge of a scheduling function in an operating system of each computer, control a performance measuring means in each processor or in a system control circuit to obtain processor operation characteristics for each process, and then assign each process to each processor on the basis of the characteristics. Therefore, as compared with the conventional system that assigns processors without taking the processor operation characteristics for each process into consideration, it is possible to realize better processor assignment, with the result that performance of the computer cluster system can be improved.

In addition, when the cluster node scheduler controls the performance measuring means to obtain a change in a memory access size, and then assigns a time slice of a processor to each process using this, start time of the time slice and a length of the time slice are optimized. This produces an effect of preventing a decrease in performance; in this case, the decrease in performance is caused by issued memory access requests that exceed the maximum memory access throughput of a node or a cluster node, resulting from the overlapped peak periods of the memory access size of the processes. Moreover, lengthening a time slice can reduce an average memory access size, which produces an effect of preventing a decrease in performance caused by concentration of memory access.

Furthermore, the performance measuring circuit performs the following processing: reading settings for performance measurement from the memory area for performance measurement control to set the settings in the performance measuring control register; counting an event, which is specified by the setting, using the performance measuring data register; and after a lapse of a predetermined period of time, storing the counted value, which has been counted using the performance measuring data register, in the memory area for performance measurement data. The performance measuring circuit performs the processing while switching the processing for each entry in the memory area for performance measurement one by one. This enables a reduction in overhead for controlling the performance measuring means by software. As a result, it is possible to obtain performance data efficiently at short sample intervals.

1. A scheduling method for assigning a process to be executed to one of a plurality of processors in a computer system comprising the plurality of processors, at least a part of said plurality of processors having a performance measuring means individually, each of said performance measuring means obtaining processor operation characteristics while executing a program of the processor, said scheduling method comprising the steps of:
when executing a process by one of said processors, obtaining said processor operation characteristics of the process by controlling said performance measuring means; and
selecting with priority a processor, to which each process is assigned, on the basis of said processor operation characteristics of each process that is being executed or can be executed in said computer.

2. A process scheduling method according to claim 1,
wherein a ratio of memory access wait time to program execution time is used as said processor operation characteristics.

3. A process scheduling method according to claim 1,
wherein a memory access size during execution of a program is used as said processor operation characteristics.

4. A process scheduling method according to claim 2,
wherein in decreasing order of said memory access wait time ratio of each process that is being executed or can be executed, each process is assigned to a processor having the largest cache capacity with first priority when assigning each of the processes.

5. A process scheduling method according to claim 2,
wherein in decreasing order of the memory access wait time ratio of each process that is being executed or can be executed on said computer, each process is assigned to a processor having the shortest memory access latency with first priority.

6. A process scheduling method according to claim 3,
wherein said computer system has a plurality of nodes, each of which comprises one or more processors; and
when assigning each of the processes, each process is assigned with priority on the basis of said memory access size of each process, which is being executed or can be executed on said computer system, so that a total memory access size of one or more processes, which are assigned to each node, does not exceed memory access performance of the node.

7. A process scheduling method according to claim 1, further comprising the step of:
recording the processor operation characteristics of each process, which have been obtained by controlling said performance measuring means, on a file system,
wherein when executing the process next time, a processor, to which the process is assigned, is selected with priority on the basis of the processor operation characteristics of the process that have been recorded on said file system.

8. A process scheduling method according to claim 2,
wherein a change in memory access characteristics of each process is obtained by controlling said performance measuring means, and when assigning a time slice of said processor to each process, a length of the time slice to be assigned to each process is changed on the basis of the change in said memory access characteristics of each process that is being executed or can be executed on said computer.

9. A process scheduling method according to claim 8,
wherein if it is detected that there is a tendency for the memory access wait time ratio or the memory access size of a process in a time slice to decrease to a level lower than a predetermined threshold value or a threshold value determined by a scheduling function on the basis of memory access characteristics of each process, a length of the time slice of the process is changed to a larger value than the predetermined value.

10. A process scheduling method according to claim 3, wherein after obtaining a change in a memory access size of each process by controlling said performance measuring means, start time of a time slice is set at different time for each process assigned to each processor in the computer, with the result that as compared with a case where time slices are started simultaneously, a decrease in performance is prevented, said decrease in performance being caused by a total memory access size of processes being executed simultaneously, which has exceeded memory access performance of the computer.

11. A computer system having a plurality of processors, wherein each of said processors has one or more performance measuring units comprising a pair of a performance measuring data register for counting the number of times a specific event has taken place from among a plurality of events that have taken place in the processor, and a performance measuring control register for indicating an event that should be measured by said performance measuring data register; and
said performance measuring unit can obtain a change in the specific event in a time slice by successively storing a value of the performance measuring data register in an area for performance measurement, which is provided in a memory of said computer system.

12. A process scheduling method according to claim 1, wherein if a part of the processors does not have the performance measuring means, a processor, to which each process is assigned, is selected with priority on the basis of memory access characteristics that have been obtained when executing the process by a processor having the performance measuring means.

13. A scheduling method for assigning a process to be executed to one of a plurality of processors in a computer system comprising the plurality of processors, at least a part of said plurality of processors having a performance measuring means individually, each of said performance measuring means obtaining processor operation characteristics while executing a program of the processor, said scheduling method comprising the steps of:
when executing a process by one of said processors, obtaining a ratio of memory access wait time to process execution time of the process as said processor operation characteristics; and
assigning a process of the highest ratio of said memory access wait time to a processor having the largest capacity cache and the smallest memory access latency.

14. A process scheduling method according to claim 13 further comprising the steps of:
obtaining the ratio of said memory access wait time for each of the plurality of processes; and
scheduling the processes in such a manner that a process of higher ratio of said memory access wait time is assigned with priority to a processor having the larger capacity cache and the smaller memory access latency.

15. A process scheduling method according to claim 14, wherein said computer system has a plurality of nodes, each of which is a processor configuration comprising one or more processors, said node sharing the same memory and being controlled by the same operating system, further comprising the steps of:
obtaining memory access throughput of each process being executed as said processor operation characteristics; and
assigning each process to the processor so that a total memory access throughput of one or more processes, which are assigned to each node, does not exceed memory access throughput performance of the node.
